(19) United States
(12) Patent Application Publication
(10) Pub. No.: US 2015/0338333 A1
(43) Pub. Date: Nov. 26, 2015

(54) METHOD FOR MEASURING OPTICALLY TRANSPARENT PARTICLES AND DEVICE FOR MEASURING OPTICALLY TRANSPARENT PARTICLES

(71) Applicant: HORIBA, Ltd., Kyoto-shi, Kyoto (JP)

(72) Inventors: Katsunobu Ehara, Kyoto-shi (JP); Akio Ishii, Kyoto-shi (JP)

(73) Assignee: HORIBA, Ltd., Koyoto-shi, Kyoto (JP)

(21) Appl. No.: 14/410,031

(22) PCT Filed: Jun. 11, 2013
(86) PCT No.: PCT/JP2013/066062

§ 371 Date: Dec. 19, 2014

(30) Foreign Application Priority Data
Jun. 25, 2012 (JP) 2012-142308

(51) Int. Cl. G01N 15/06; G01N 21/51

(52) U.S. Cl. CPC G01N 15/06; G01N 21/51; G01N 2015/0693

(57) ABSTRACT

The present invention is one that, without performing a complicated measuring process, makes it possible to continuously measure optically transparent particles including a biologically-derived polysaccharide having a negatively-charged functional group, such as transparent exopolymer particles (TEP), and includes: a dyeing step of adding to a sample solution a dye that binds to the negatively-charged functional group of the optically transparent particles to dye the optically transparent particles; an aggregation step of reducing the ionic strength of the sample solution to aggregate the optically transparent particles; and a turbidity measuring step of irradiating inspection light to the dyed and aggregated optically transparent particles, and detecting transmitted light caused by the optically transparent particles to measure the turbidity of the sample solution.

### TECHNICAL FIELD

The present invention relates to a method and device for measuring optically transparent particles that include a biologically-derived polysaccharide having a negatively-charged functional group, such as transparent exopolymer particles (TEP).

### BACKGROUND ART

There is a conventional seawater desalination process, as described in Patent Literature 1, that preprocesses seawater using a UF membrane (ultrafiltration membrane) and/or an MF membrane (microfiltration membrane), and then separates salt through an RO membrane (reverse osmosis membrane) to obtain fresh water (reverse osmotic method).

Meanwhile, clogging of an RO membrane is problematic, and if an RO membrane is clogged, a plant should be stopped for maintenance of the RO membrane. Note that as a cause of clogging of an RO membrane, transparent exopolymer particles (TEP) are considered, so that in the case where the concentration of TEP in seawater supplied to an RO membrane is high, the risk of clogging the RO membrane is increased, and therefore it is desired to measure the TEP concentration in seawater.

Conventional TEP measurement includes: (1) a filtration step of filtering a collected sample solution; (2) a dyeing step of adding a dye to a filter cake containing TEP, which is separated by the filtration step, to dye the TEP; (3) an extraction step of adding sulfuric acid (H₂SO₄) to the filter cake having undergone the dyeing step and thereby extract a bound substance of the dye and the TEP; and (4) a TEP quantification step of quantifying the TEP from the absorbance of the bound substance of the dye and the TEP, which is extracted by the extraction step.

However, the conventional TEP measurement has problems in that it is necessary to extract TEP to measure the absorbance through the above complicated steps (1) to (4), and also it takes time before the extraction. Also, waste liquid is a strong acid containing sulfuric acid, and therefore requires not only sufficiently careful handling but also cost for disposal. Further, when measuring the absorbance, the inner surface of a measuring cell is dyed by the dye, which requires frequent cleaning or replacement of the measuring cell, thus resulting in complicated operations. In addition, it is difficult to perform continuous measurement or on-site measurement.

### CITATION LIST

### Patent Literature

Patent Literature 1: JP-A2010-58080

### SUMMARY OF INVENTION

### Technical Problem

Therefore, the present invention is made in order to solve the above problems at once, and a main intended object thereof is to make it possible to, without performing a complicated measuring process, simply measure optically transparent particles including a biologically-derived polysaccharide having a negatively-charged functional group, such as transparent exopolymer particles (TEP), and also perform continuous measurement.

### Solution to Problem

That is, the method for measuring optically transparent particles according to the present invention is a method for measuring optically transparent particles that are contained in a sample solution and include a biologically-derived polysaccharide having a negatively-charged functional group, and includes: a dyeing step of adding to the sample solution a dye that binds to the negatively-charged functional group of the optically transparent particles to dye the optically transparent particles; an aggregation step of reducing ionic strength of the sample solution to aggregate the optically transparent particles; and a turbidity measuring step of irradiating inspection light to the optically transparent particles dyed and aggregated respectively by the dyeing step and the aggregation step, and detecting scattered light caused by the optically transparent particles to measure a turbidity of the sample solution.

Such a method for measuring optically transparent particles is one that uses the dye to dye the optically transparent particles, reduces the ionic strength of the sample solution to aggregate the optically transparent particles, and detects the scattered light caused by the dyed and aggregated optically transparent particles, and therefore without the need for performing a complicated measuring process, makes it possible to simply perform measurement, and perform continuous measurement and on-site measurement.

Desirably, the optically transparent particles are transparent exopolymer particles, and by adding an alcian blue solution into the sample solution as the dye, the dyeing step and the aggregation step are simultaneously performed. Alcian blue is positively charged to easily ionically bind to the TEP having the negatively charged functional group, and therefore preferable for dyeing the TEP. Also, by adding the alcian blue solution, the sample solution is diluted to reduce the ionic strength of the sample solution, and consequently the TEP easily aggregate. As described, only by adding the alcian blue solution to the sample solution, the TEP can be dyed and aggregated, and therefore a measuring process of the TEP can be made extremely simple to continuously measure the TEP.

A device for measuring optically transparent particles for preferably enacting the method for measuring optically transparent particles is a device for measuring optically transparent particles that are contained in a sample solution and include a biologically-derived polysaccharide having a negatively-charged functional group, and includes: dye adding means adapted to add to the sample solution a dye that binds to the negatively-charged functional group of the optically transparent particle to dye the optically transparent particles; aggregation means adapted to reduce ionic strength of the sample solution to aggregate the optically transparent particles; and turbidity measuring means adapted to irradiate inspection light to the optically transparent particles dyed and aggregated respectively by the dye adding means and the aggregation means, and detect transmitted light and scattered light caused by the optically transparent particles to measure a turbidity of the sample solution.

Such a device for measuring optically transparent particles can automatically measure the optically transparent particles contained in the sample solution only by placing a cell containing the sample solution. Also, the optically transparent particles are not only dyed using the dye but also aggregated, and therefore the light intensities of the transmitted light and the scattered light caused by the optically transparent particles can be increased to improve measurement accuracy of the optically transparent particles. In this case, the dyed and aggregated optically transparent particles may be measured by absorbance measurement; however, the inner surface of the measuring cell is dyed by the dye, which absorbs light, and consequently a measurement error occurs. In the present invention, the turbidity is measured using the transmitted light and the scattered light, and therefore the measurement error caused by the dye adsorbed on the inner surface of the measurement cell can be reduced to measure the optically transparent particles with accuracy. Also, the turbidity may be measured without dyeing or aggregating the optically transparent particles with the dye; however, sufficient sensitivity cannot be obtained for the turbidity measurement. In the present invention, the optically transparent particles are aggregated, so that the turbidity is increased, and therefore the sensitivity can be sufficiently ensured to improve measurement accuracy.

Note that in order to simplify a device configuration of the device to enable, for example, downsizing or the like, preferably, the dye adding means also serves as the aggregation means.

### Advantageous Effects of Invention

The present invention configured as described makes it possible to, without performing a complicated measuring process, continuously measure optically transparent particles including a biologically-derived polysaccharide having a negatively-charged functional group, such as transparent exopolymer particles (TEP).

### BRIEF DESCRIPTION OF DRAWINGS

FIG. 1 is a schematic diagram of a TEP measuring device of the present embodiment.

FIG. 2 is a flowchart of a TEP measuring method of the same embodiment.

FIG. 3 is an experimental result graph illustrating the relationship between TEP concentration and turbidity.

FIG. 4 is an experimental result graph illustrating the relationship between the TEP concentration and the turbidity in the presence and absence of an interference component.

FIG. 5 is an experimental result graph illustrating the relationship between alcian blue concentration and turbidity.

FIG. 6 is an experimental result graph illustrating the relationship between ionic strength and sensitivity.

### REFERENCE CHARACTER LIST

100 Optically transparent particle measuring device (TEP measuring device)
S Measuring cell
2 Dye adding means
3 Aggregation means
4 Turbidity measuring means
41 Light source
L1 Inspection light
L2 Transmitted light
L3 Scattered light
42 Light detector for transmitted light
43 Light detector for scattered light
5 Calculation means

### DESCRIPTION OF EMBODIMENTS

An optically transparent particle measuring device according to the present invention will hereinafter be described with reference to the drawings.

An optically transparent particle measuring device 100 of the present embodiment is a TEP measuring device that measures transparent exopolymer particles (TEP) that are optically transparent particles contained in seawater, industrial wastewater, domestic wastewater, or the like. Note that the transparent exopolymer particles (TEP) are a viscous polymeric substance causing a biofilm, have a negatively-charged functional group on the surface, and include a polysaccharide produced from organisms such as microorganisms.

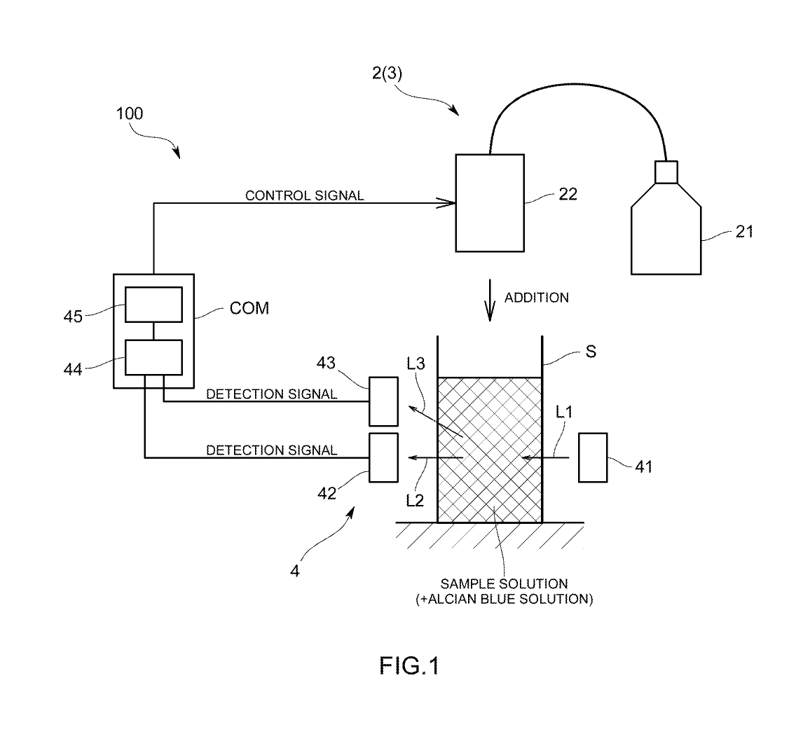

Specifically, as illustrated in FIG. 1, the optically transparent particle measuring device 100 includes: dye adding means 2 adapted to add a dye for dyeing TEP to a sample solution contained in a measuring cell S; aggregation means 3 adapted to reduce the ionic strength of the sample solution contained in the measuring cell S to aggregate the TEP; and turbidity measuring means 4 adapted to irradiate inspection light L1 to the TEP dyed and aggregated respectively by the dye adding means 2 and the aggregation means 3, and detect transmitted light L2 and scattered light L3 caused by the TEP to measure the turbidity of the sample solution. Note that the measuring cell S may be a batch type one or a flow type one.

The dye adding means 2 of the present embodiment is one adapted to add an alcian blue solution to the sample solution inside the measuring cell S as a dye having a positively-charged functional group, and includes: a dye container 21 that contains the alcian blue solution; and a dye supplying mechanism 22 that supplies the alcian blue solution in the dye container 21 into the measuring cell S and has an on/off valve, a pump, and the like. In addition, the dye supplying mechanism 22 is controlled by an unillustrated control part on the basis of a measuring sequence.

The dye adding means 2 supplies the dye into the measuring cell S to dye the TEP contained in the sample solution. On this occasion, the dye adding means 2 supplies the alcian blue solution into the measuring cell S, and thereby the sample solution is diluted, or the positively-charged alcian blue solution reduces the ionic strength to aggregate the TEP. That is, the dye adding means 2 of the present embodiment has a function as the aggregation means 3.

Note that in the case where an additive amount of the alcian blue solution is too small, the dyeing and aggregation of the TEP become insufficient, and thereby sufficient sensitivity cannot be obtained for the turbidity measurement by the turbidity measuring means 4. On the other hand, in the case where an additive amount of alcian blue is too large, the dyeing of the TEP becomes excessive, and an aggregation amount based on the reduction in ionic strength becomes too large, causing precipitation to give rise to a measurement error by the turbidity measuring means 4. For these reasons, an additive amount of the alcian blue solution is desirably set to a level that makes it possible for the turbidity measuring means 4 to obtain predetermined sensitivity and prevents the TEP from precipitating.

Also, the turbidity measuring means 4 includes: a light source 41 that irradiates the sample solution in the measuring cell S with the inspection light L1; a transmitted light detector 42 that detects the transmitted light L2 transmitted through the sample solution irradiated with the inspection light L1; a scattered light detector 43 that detects the scattered light L3 scattered by the sample solution irradiated with the inspection light L1; and a turbidity calculation part 44 that obtains detection signals (light intensity signals) from the transmitted light detector 42 and the scattered light detector 43 to calculate the turbidity from the light intensity signals. Further, the turbidity measuring means 4 has a TEP concentration calculation part 45 that calculates the TEP concentration on the basis of the turbidity obtained by the turbidity calculation part 44 and a preliminarily inputted calibration curve. In the present embodiment, an information processor COM that fulfills functions as the turbidity calculation part 44 and the TEP concentration calculation part 45 is configured to fulfill functions as a control part adapted to control the light source 41 and the control part adapted to control the dye supplying mechanism 22.

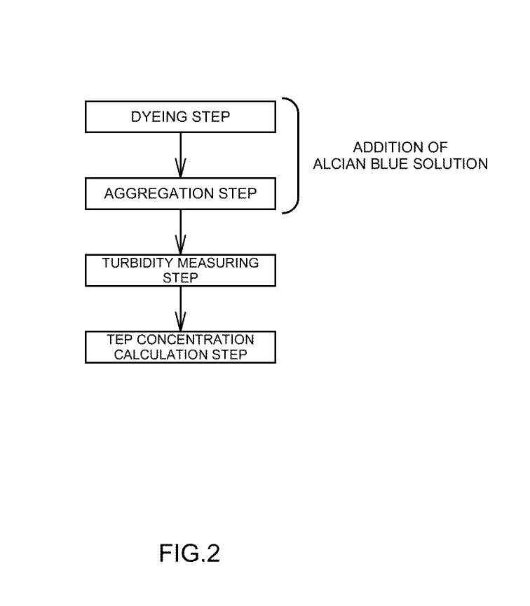

Next, a TEP measuring method is described with reference to FIG. 2 together with the action of the TEP measuring device 100 configured as described.

The TEP measuring method of the present embodiment includes: (1) a dyeing step of adding the alcian blue solution to the sample solution; (2) an aggregation step of reducing the ionic strength of the sample solution to aggregate the TEP; (3) a turbidity measuring step of irradiating the inspection light L1 to the TEP dyed and aggregated respectively by the dyeing step and the aggregation step, and detecting the transmitted light L2 and the scattered light L3 caused by the TEP to measure the turbidity of the sample solution; and (4) a TEP concentration calculation step of calculating the TEP concentration from the measured turbidity. In addition, the dyeing step and the aggregation step are set as simultaneous steps that are simultaneously performed by adding the alcian blue solution to the sample solution.

After the dyeing and aggregation steps using the alcian blue solution, the inspection light L1 is irradiated from the light source 41 of the turbidity measuring means 4, then the transmitted light L2 and the scattered light L3 caused by the irradiation of the inspection light L1 are respectively detected by the transmitted light detector 42 and the scattered light detector 43, and the turbidity calculation part 44 measures the turbidity of the sample solution using a ratio between the transmitted light intensity and the scattered light intensity respectively obtained by the corresponding light detectors 42 and 43, and the like. Subsequently, the TEP concentration calculation part 45 calculates the concentration of the TEP contained in the sample solution from the turbidity obtained by the turbidity measuring step. Note that the calibration curve used for the calculation is preliminarily stored in a storage part that is provided in an internal memory or the like of the information processor COM.

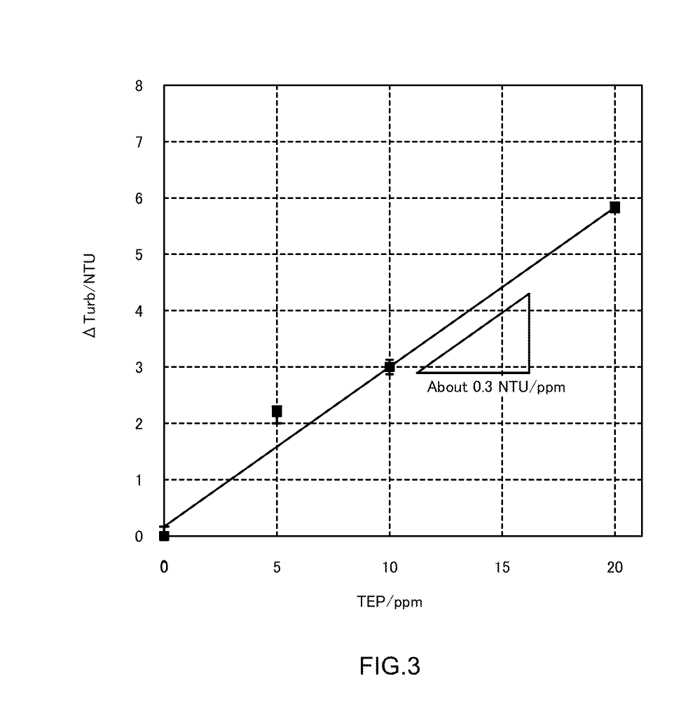

Next, the correlation between the TEP concentration and the turbidity is described with reference to FIG. 3. FIG. 3 illustrates the relationship between the concentration of xanthan gum contained in a sample solution and turbidity in the case where the xanthan gum is used as a standard substance for the TEP, and dyed using a 0.1% alcian blue solution, and also the salinity of the sample solution is adjusted to 1.35%.

As can be seen from FIG. 3, as the concentration of the xanthan gum is increased from 0 ppm to 20 ppm, the turbidity [NTU] obtained also proportionally increases. Specifically, it turns out that the turbidity increases at a rate of approximately 0.3 NTU/ppm. That is, it turns out that the TEP concentration can be quantified using the turbidity measuring means 4. Note that an expression representing the relationship between the turbidity and the concentration serves as the above-described calibration curve.

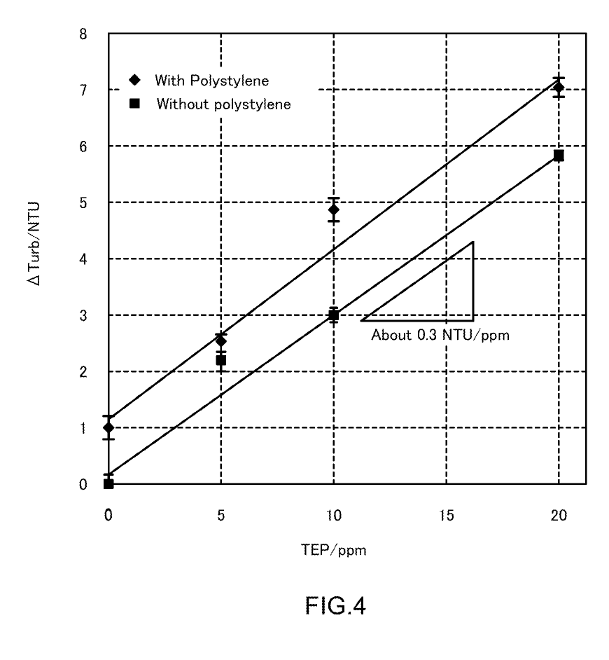

Next, correlations between the TEP concentration and the turbidity in the presence and absence of an interference component are described with reference to FIG. 4. In FIG. 4, polystyrene is used as the interference component, and the presence of the interference component refers to the case where 1 NTU of polystyrene is contained in the sample solution. The other conditions are the same as those in FIG. 3.

As can be seen from FIG. 4, even in the case where the interference component is present in the sample solution, as the concentration of the xanthan gum is increased from 0 ppm to 20 ppm, the turbidity [NTU] obtained also proportionally increases. That is, it turns out that even in the case where the interference component is present in the sample solution, the TEP concentration can be quantified using the turbidity measuring means 4.

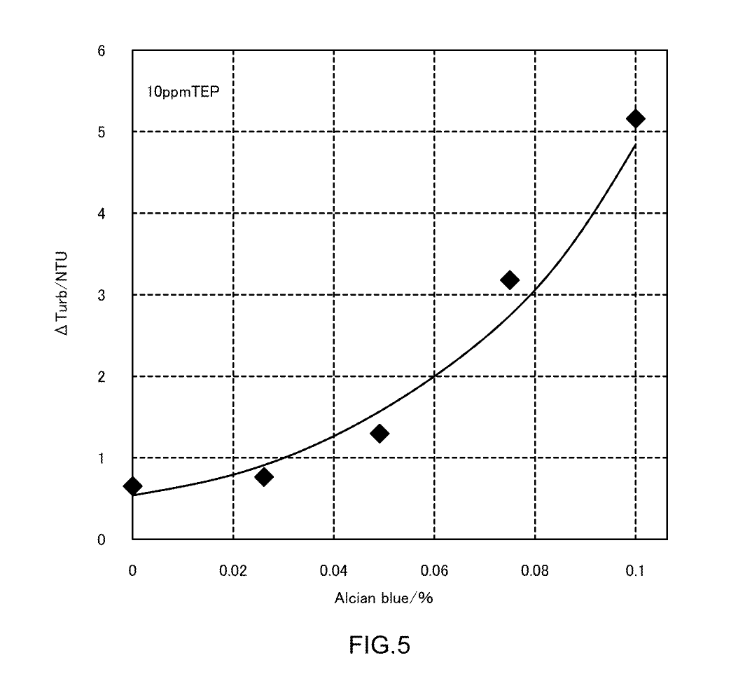

Next, a change in turbidity depending on the concentration of the alcian blue solution is examined. FIG. 5 illustrates a change in turbidity in the case where the alcian blue solution is added to a sample solution having a salinity of 13.5 gL⁻¹ and a TEP concentration of 10 ppm.

As can be seen from FIG. 5, as the concentration of the alcian blue solution is increased, the turbidity increases. Note that as the concentration of the alcian blue solution is increased, the ionic strength of the sample solution reduces, and therefore the TEP tend to precipitate because the aggregation of the TEP is facilitated.

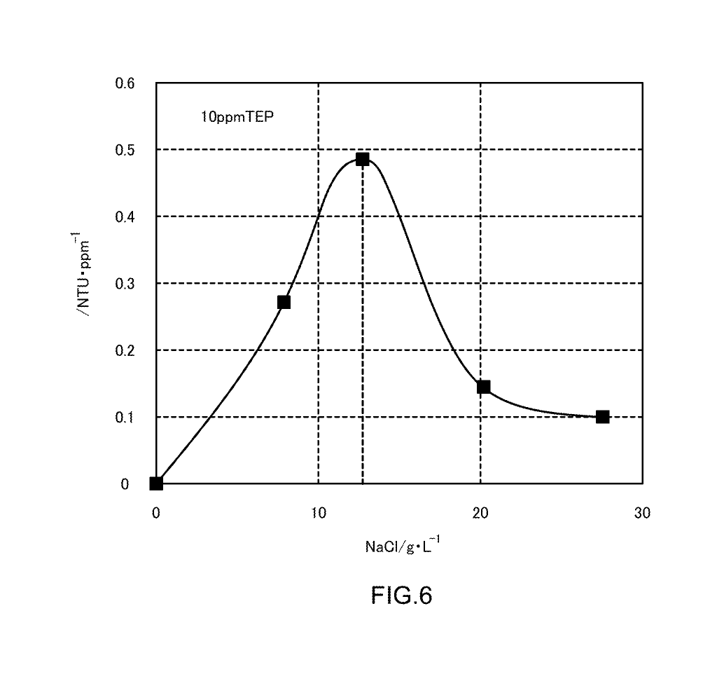

Next, a change in turbidity sensitivity depending on the ionic strength (salinity) is examined. FIG. 6 illustrates a change in turbidity sensitivity in the case of changing the ionic strength of a sample solution having a TEP concentration of 10 ppm by changing an addition amount of a 0.2% alcian blue solution to the sample solution.

As can be seen from FIG. 6, as the ionic strength is reduced, the turbidity sensitivity increases and has a peak at approximately 13.5 gL⁻¹. After that, as the ionic strength is further reduced, the turbidity sensitivity reduces. It is considered that in the case of reducing the ionic strength too much as described, an aggregation amount of the TEP is increased to precipitate the TEP, and consequently the turbidity sensitivity reduces. The salinity at which the measurement sensitivity has the peak is approximately half the salinity of seawater.

The TEP measuring device 100 and TEP measuring method according to the present embodiment configured as described are ones that use the dye to dye the optically transparent particles, reduce the ionic strength of the sample solution to aggregate the optically transparent particles, and detect the scattered light caused by the dyed and aggregated optically transparent particles, and make it possible to perform continuous measurement (on-site measurement) without the need for performing a complicated measuring process. Note that to aggregate the optically transparent particles, it is only necessary to, for example, dilute the sample solution to reduce the ionic strength of the sample solution, and therefore the measuring process is easy. Also, the TEP is not only dyed using the dye but also aggregated, so that the light intensities of the transmitted light L2 and the scattered light L3 caused by the TEP can be increased, and therefore measurement accuracy of the TEP can be improved. At this time, the transmitted light L2 and the scattered light L3 are used to measure the turbidity, and therefore a measurement error caused by the dye adsorbed on the inner surface of the measuring cell S can be reduced to measure the TEP with accuracy. Further, the ionic strength is reduced to aggregate the TEP, so that the turbidity can be increased to sufficiently achieve the sensitivity, and consequently the measurement accuracy can be improved.

In addition, only by adding the alcian blue solution to the sample solution, the TEP can be dyed and aggregated, so that the measurement process of the TEP can be made extremely simple, and therefore the continuous measurement of the TEP can be performed.

Note that the present invention is not limited to the above-described embodiment.

For example, in the above-described embodiment, alcian blue is used as the dye; however, besides this, various dyes can be used as long as the dyes bind to the negatively-charged functional group of the optically transparent particles such as TEP. For example, a toluidine blue solution or a colloidal iron solution can be used.

Also, in the above-described embodiment, the TEP is exemplified as the optically transparent particles; however, any optically transparent particles including a biologically-derived polysaccharide having a negatively-charged functional group are also applicable.

Further, in the above-described embodiment, the alcian blue solution is used to simultaneously perform the dyeing step and the aggregation step; however, besides this, the dyeing step and the aggregation step may be separately performed. If so, an additive amount of the dye for realizing the optimum dyeing and a dilution amount for reducing the ionic strength in order to realize the optimum aggregation can be separately controlled. In addition, either one of the dyeing step and the aggregation step may be performed first.

Furthermore, it goes without saying that the present invention is not limited to any of the above-described embodiments, but can be variously modified without departing from the scope thereof.

### INDUSTRIAL APPLICABILITY

The present invention makes it possible to, without performing a complicated measuring process, continuously measure optically transparent particles including a biologically-derived polysaccharide having a negatively-charged functional group, such as transparent exopolymer particles (TEP).

1. A method for measuring optically transparent particles that are contained in a sample solution and include a biologically-derived polysaccharide having a negatively-charged functional group, the method comprising:
a dyeing step of adding a dye to the sample solution, the dye binding to the negatively-charged functional group of the optically transparent particles to dye the optically transparent particles;
an aggregation step of reducing ionic strength of the sample solution to aggregate the optically transparent particles; and
a turbidity measuring step of irradiating inspection light to the optically transparent particles dyed and aggregated respectively by the dyeing step and the aggregation step, and detecting scattered light caused by the optically transparent particles to measure a turbidity of the sample solution.

2. The method for measuring optically transparent particles according to claim 1, wherein:
the optically transparent particles are transparent exopolymer particles; and
by adding an alcian blue solution to the sample solution as the dye, the dyeing step and the aggregation step are simultaneously performed.

3. A device for measuring optically transparent particles that are contained in a sample solution and include a biologically-derived polysaccharide having a negatively-charged functional group, the device comprising:
dye adding means adapted to add a dye to the sample solution, the dye binding to the negatively-charged functional group of the optically transparent particles to dye the optically transparent particles;
aggregation means adapted to reduce ionic strength of the sample solution to aggregate the optically transparent particles; and
turbidity measuring means adapted to irradiate inspection light to the optically transparent particles dyed and aggregated respectively by the dye adding means and the aggregation means, and detect transmitted light and scattered light caused by the optically transparent particles to measure a turbidity of the sample solution.
